(19) United States
(12) Patent Application Publication
(10) Pub. No.: US 2006/0142083 A1
(43) Pub. Date: Jun. 29, 2006

(54) Gaming machine

(75) Inventor: Junichi Kogo, Tokyo (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: Aruze Corp., Tokyo (JP)

(21) Appl. No.: 11/290,429

(22) Filed: Dec. 1, 2005

(30) Foreign Application Priority Data
Dec. 7, 2004 (JP) 2004-353741
Dec. 7, 2004 (JP) 2004-353777

(51) Int. Cl. A63F 9/24; A63F 13/00

(52) U.S. Cl. 463/36; 463/37

(57) ABSTRACT

While the typing game is executed, if it is determined that the character of the key 2001 input coincides with the character displayed on the display, the LEDs 2302, 2303 within the key 2001 input are temporarily turned on in blue color, thereby the keytop 2401 of the key 2001 input is temporarily colored in blue color. On the other hand, if it is determined that the character of the key 2001 input does not coincide with the character displayed on the display, the LEDs 2302, 2303 within the key 2001 input is temporarily turned on in red color, thereby the keytop 2402 of the key 2001 input is temporarily colored in red color. Therefore, the player can confirm on the keyboard 3 whether press and operation of the key 2001 is correct or false, through the color of the keytop 2401 of the key 2001 right after the key 2001 is input.

### CROSS-REFERENCE TO THE RELATED APPLICATION(S)

This application is based upon and claims a priority from the prior Japanese Patent Application Nos. 2004-353741 filed on Dec. 7, 2004, and 2004-353777 filed on Dec. 7, 2004, the entire contents thereof are incorporated herein by reference.

### BACKGROUND OF THE INVENTION

1. Field of the Invention

The present invention relates to a gaming machine in which a typing game is conducted.

2. Description of Related Art

Recently, frequency to use a computer increases. And it is general that input to the computer is conducted from a keyboard in which there are arranged keytops on each of which input information such as a character, numeral or mark is attached. Further, for a beginner, arrangement of the keytops with the input information is hard to remember, thus it is required for the beginner to train to an extent in order for smoothly key input. And even if a user of the keyboard masters key input to an extent, it is further required to train key input in order to further shorten an input time of key input, and it is generally difficult for the user to conduct such training in many cases. Thus, to support training for typing, a typing game in which various devices are planned is conventionally proposed.

For example, in a typing game device described in Unexamined Japanese patent Publication No. 2003-62331, key input is conducted on the keyboard to indicate solution for questions while solving questions proposed on a screen of a display device, thereby training for typing can be done while enjoying.

On the other hand, in the keyboard inevitable for the typing game, although the input information such as the character, numeral or mark is attached to the keytop, there exits a keyboard in which three-dimensional display or illumination display of the input information is done on the keytop in order to easily understand the input information, as disclosed in Unexamined Japanese Patent Publication No. 2002-23924 and in Japanese Registered Utility Model Publication No. 3101665.

Further, there exists a keyboard in which positions of the keytops necessary to press and operate are emphasized and displayed by passing light through the keytops which are made transparent or semi-transparent, as disclosed in Japanese Registered Utility Model Publication No. 3082585.

Therefore, by using any of the above keyboards in the typing game, the three-dimensional display, illumination display or emphasized display of the input information attached to the keytops is conducted, and positions of the input information such as the character, numeral or mark can be easily recognized, thereby support of training for typing, which is one object of the typing game, can be realized, and as a result, a typing game having interest different from that of the conventional typing game is also provided.

However, taking into consideration situation to realize support of training for typing, which is one object of the typing game, there is tendency to regard input to the computer as important, and standing on the real situation, in spite that many players conduct key input while seeing the keyboard, it is out of thought that training is done by using a specific keyboard capable of displaying that key input is right or false. Reversely, there is conventionally lack in thought to provide a typing game in which it is displayed that key input is right or false, and as a result, to which it is given interest different from that of the conventional typing game.

And taking into consideration situation to realize support of training for typing, which is one object of the typing game, there is tendency to make easy to recognize a position of the input information attached to the keytop, and standing on the real situation, it is out of thought that training for typing is done by using the keyboard having the keys to each of which the key information is not attached. Reversely, based on that the position of the key information attached to the keytop is made hard to recognize, as a result, there is conventionally lack in thought to provide a typing game with interest different from that of the conventional typing game.

### SUMMARY OF THE INVENTION

In order to dissolve the above problems, the present invention has been done and has an object to provide a gaming machine in which a typing game with interest different from that of the conventional typing game can be conducted.

In order to accomplish the above object, according to one aspect of the present invention, it is provided a gaming machine comprising:

a display device for displaying input information thereon;

a keyboard for conducting key input corresponding to the input information displayed on the display device, the keyboard being provided with a plurality of keys each of which includes a transparent keytop on which key information is attached and an illumination element capable of emitting full color light, the illumination element being covered by the keytop;

an input determination device for determining whether or not the key information input through the key coincides with the input information displayed on the display device; and

an illumination control device for controlling the illumination element so as to turn on while changing a light color depending upon a determination result by the input determination device.

In the above gaming machine, the input determination device determines whether or not the key information input through the key coincides with the input information displayed on the display device, and the illumination control device controls the illumination element so as to turn on while changing a light color depending upon a determination result by the input determination device. Thereby, the determination result can be confirmed on the keyboard, thus it can be conducted a typing game with interest different from that of the conventional typing game.

And according to another aspect of the present invention, it is provided a gaming machine comprising:

a display device for displaying input information thereon;

a keyboard for conducting key input corresponding to the input information displayed on the display device, the keyboard being provided with a plurality of keys each of which includes a transparent keytop on which key information is attached and an illumination element capable of emitting full color light, the illumination element being covered by the keytop;

an input determination device for determining whether or not the key information input through the key coincides with the input information displayed on the display device; and

an illumination control device for conducting illumination control of the illumination element so as to assimilate the key information with the transparent keytop.

According to the above gaming machine, the input determination device determines whether or not the key information input through the key coincides with the input information displayed on the display device, and the illumination control device conducts illumination control of the illumination element so as to assimilate the key information with the transparent keytop. Thereby, a position of the key information attached on the keytop becomes hard to recognize, thus it can be conducted a typing game with interest different from that of the conventional typing game.

The above and further objects and novel features of the invention will more fully appear from the following detailed description when the same is read in connection with the accompanying drawings. It is to be expressly understood, however, that the drawings are for purpose of illustration only and not intended as a definition of the limits of the invention.

### BRIEF DESCRIPTION OF THE DRAWINGS

The accompanying drawings, which are incorporated in and constitute a part of this specification illustrate embodiments of the invention and, together with the description, serve to explain the objects, advantages and principles of the invention.

In the drawings,

FIG. 1 is an outline view of a typing training system,

FIG. 2 is a block diagram of the typing training system,

FIG. 3 is an outline view showing a typing game screen in the typing training system,

FIG. 4 is an outline view showing a music input screen for inputting a music title,

FIG. 5 is a flowchart of a main routine for the typing training system according to the embodiment,

FIG. 6 is a flowchart of a music selection routine,

FIG. 7 is a flowchart of a typing game play routine,

FIG. 8 is a flowchart of a phrase display routine,

FIG. 9 is a flowchart of a key display selection routine,

FIG. 10 is a flowchart of an input key solution display routine,

FIG. 11 is a flowchart of an input key mistake display routine,

FIG. 12 is a flowchart of an input key navigation display routine,

FIG. 13 is an outline view showing a key display selection screen for selecting key display,

FIG. 14 is an outline sectional view showing a key by sectioning any one of plural keys provided on a keyboard,

FIG. 15 is a block diagram of the keyboard,

FIG. 16 is an outline view showing the keyboard when a normal mode is set,

FIG. 17 is an outline view showing the keyboard when a support mode is set, and

FIG. 18 is an outline view showing the keyboard when a higher class mode is set.

### DETAILED DESCRIPTION OF THE PREFERRED EMBODIMENTS

Hereinafter, the preferred embodiment according to the present invention will be described with reference to the drawings.

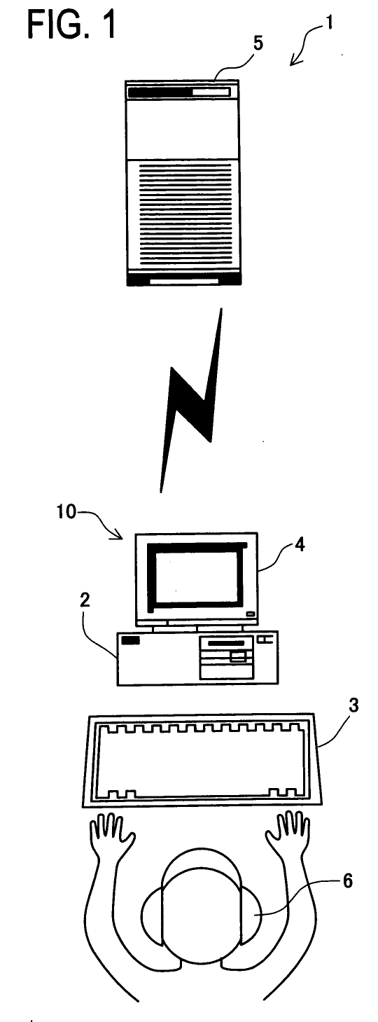

In the embodiment, a typing training system 1 is a system through which a typing game is conducted so that a player can smoothly train key input without seeing a keyboard (hereinafter, called as “blind touch”), and as shown in FIG. 1, this system is provided with a server 5 and a PC (personal computer) 10 (terminal device).

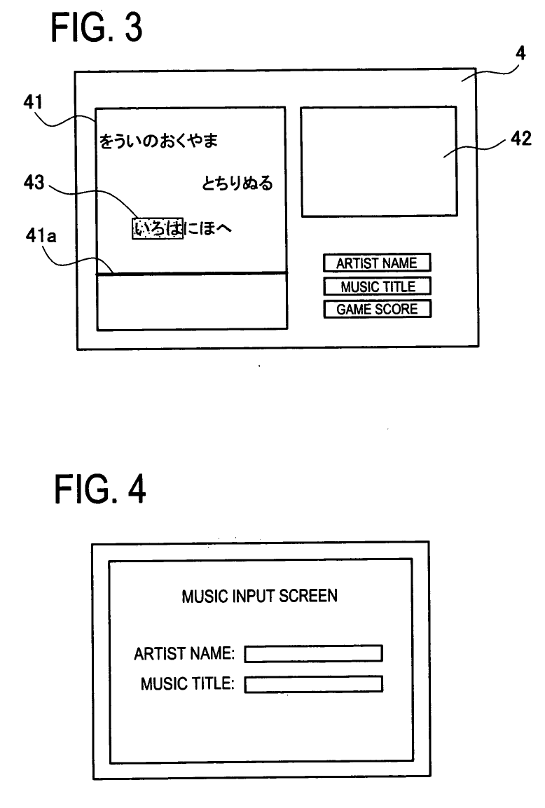

At first, the typing game done in the typing training system 1 will be described. This typing game is a game in which the player types out a text of music displayed on screen of a display 4 while hearing the music through a pair of headphones 6. Here, typing means to input keys on a keyboard 3 corresponding to characters displayed. As shown in FIG. 3, at the left portion of the display 4, a character display screen 41 is displayed as mentioned later and a character line (text data) corresponding to one phrase formed by dividing the text of music into plural phrases appears from an upper portion of the character input screen 41 and moves toward a lower portion thereof. As mentioned later, although the character line is constructed from characters with more than one character kind, when the character line is displayed on the character input screen 41, the character line in which the characters are converted into the character kind selected, that is, the character line constructed from the characters with the same character kind is displayed, as shown in FIG. 3.

Under the character input screen 41, a timing line 41a is formed and the player inputs keys corresponding to the characters from the keyboard 3 so as to coincide with each of the characters constructing the character line displayed on the character input screen 41 during a predetermined time till the character line exceeds the timing line 41a since the character line appears from the upper portion of the character input screen 41 and moves toward the lower portion thereof. And at the right side of the character input screen 41, a picture screen is displayed and a picture concerning with the music being played, for example, a promotion video of the music being played is displayed. Further, under the picture screen 42, there are displayed an artist name of the music being played, a music title and a game score are displayed. Here, the game score indicates an index showing typing ability of the player, the game score being determined by a score based on a typing result done by the player.

The PC 10 has a body 2, a keyboard 3, a display 4 and headphones 6. The display 4 is a display device to display the typing game screen and a music input screen shown in FIG. 4, based on a display control signal output from the body 2. And the keyboard 3 is means to input keys corresponding to the characters, marks, numerals, the keys of “A˜Z”, “ [symbol] ”, “9˜0”, period, comma and determination key being arranged in plural lines. And the keyboard is also means to input and select the music title and the character kind.

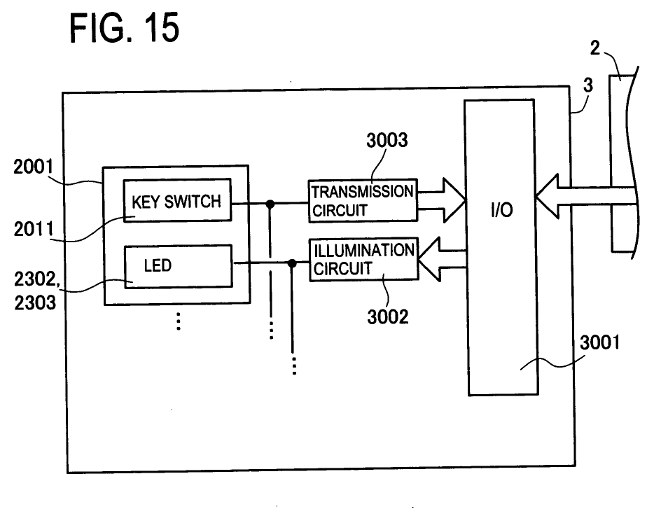

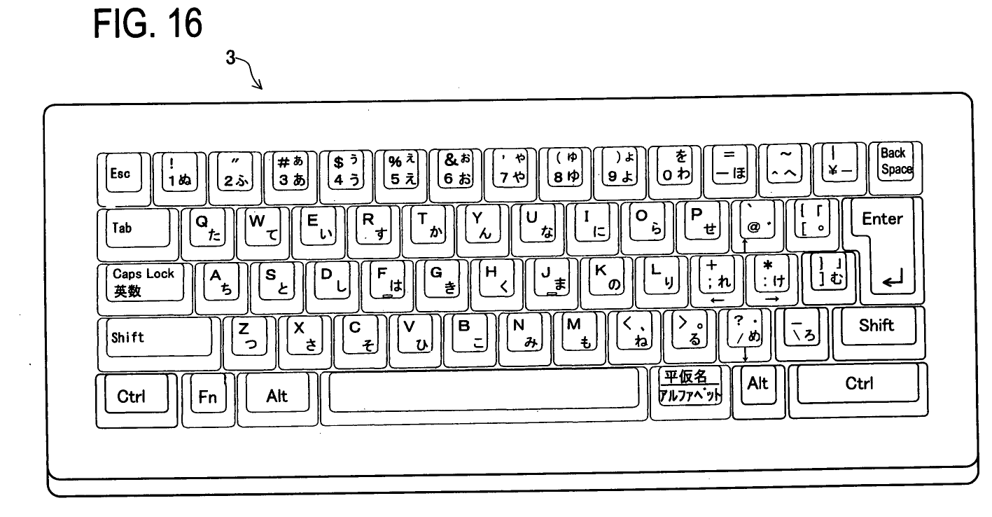

Here, construction of the keyboard 3 will be described. FIG. 14 is a schematic sectional view sectioned any one of plural keys provided on the keyboard. And FIG. 15 is a block diagram of the keyboard.

As shown in FIG. 14, the key 2001 is constructed from a base plate 2101, a switch circuit board 2201, an illumination circuit board 2301, a keytop 2401 and urging mechanisms 2501 and 2502.

Here, on the switch circuit board 2201 mounted on the base plate 2101, there are arranged a pair of electrodes 2202, 2203 positioned at right under positions of substantial center of the keytop 2401.

And on the illumination circuit board 2301 mounted on the switch circuit board 2201, openings 2305 to expose the pair of the electrodes 2202, 2203, and LEDs 2302, 2303 capable of illuminating with full color light are arranged around the openings 2305.

And between the illumination circuit board 2305 and the keytop 2401, the urging mechanisms 2501, 2502 are arranged and the keytop 2401 is urged toward the opposite side of the switch circuit board 2201. Further, near center of the keytop 2401 a movable electrode 2403 is protruded toward the switch circuit board 2201. Therefore, when the keytop 2401 is pressed downward, the movable electrode 2403 protruded from the keytop 2401 contacts with the pair of the electrodes 2202, 2203 formed on the switch circuit board 2201. Thereby, it can be transmitted through an electric signal flowing in the switch circuit board 2201 that keytop 2401 is pressed and operated. Accordingly, three electrodes 2202, 2203 and 2403 construct the key switch 2011.

Here, the urging mechanisms 2501, 2502 may be constructed from only an elastic member or an elastic member and bridge mechanism. Such urging mechanisms are not limited to the above construction.

And the keytop 2401 is made of material with light transmissive ability (for example, transparent acrylic resin, transparent plastic), and the key information 2402 such as character, numeral, mark is printed on the plane opposite to the switch circuit board 2201. Here, the key information 2402 is printed in black color, and the surface 2304 of the illumination circuit board 2301 facing to the keytop 2401 is also printed in black color. Therefore, when the LEDs 2302, 2303 are turned off, the keytop 2401 with transmissive ability is recognized in black color which is the color of the surface 2304 of the illumination circuit board 2301. Thus, the key information 2402 printed in black color on the keytop 2401, which is recognized in black color, is made hard to recognize, or is made impossible or difficult to recognize through eyes. On the contrary, when the LEDs 2302, 2303 are turned on, the keytop 2401 with transmissive ability is recognized with the color which is the color illuminated by light emitted from the LEDs 2302, 2303, thereby the key information 2402 printed in black color on the keytop 2401 can be easily recognized on the basis of the color illuminated by light emitted from the LEDs 2302, 2303.

And as shown in FIG. 15, in the keyboard 3, the key switch 2011 within the key 2001 is connected to a signal transmission circuit 3003. Further, the signal transmission circuit 3003 is connected to the body 2 through an interface unit (hereinafter, abbreviated as I/O) 3001 of the keyboard 3. Therefore, an electric signal from the key switch 2011 of the key 2001 which is pressed is transmitted to the body 2 through the signal transmission circuit 3003, thereby the pressed key 2001 can be specified in the body 2. Here, the signal transmission circuit 3003 is mounted on the switch circuit board 2201.

And as shown in FIG. 15, in the keyboard 3, the LEDs 2302, 2303 within the key 2001 are connected to an illumination circuit 3002. Further, the illumination circuit 3002 is connected to the body 2 through an I/O 3001 of the keyboard 3. Therefore, the LEDs 2302, 2303 within the key 2001 specified by the body 2 can be turned on in a specific color specified by the body 2 through the illumination circuit 3002. Here, the illumination circuit 3002 is mounted on the illumination circuit board 2301.

Here, in FIGS. 14 and 15, although only one key 2001 is shown, each of the keys 2001 arranged in the keyboard 3 has the same construction and function as that in the key 2001 mentioned in the above.

Returning to FIG. 1, the headphones 6 are output devices through which the player hear the music. While hearing the music output through the headphones 6, the player conducts key input from the keyboard 3 based on the character line displayed on the screen of the display 4, thereby the player can train blind touch. Here, the headphones 6 may be speakers.

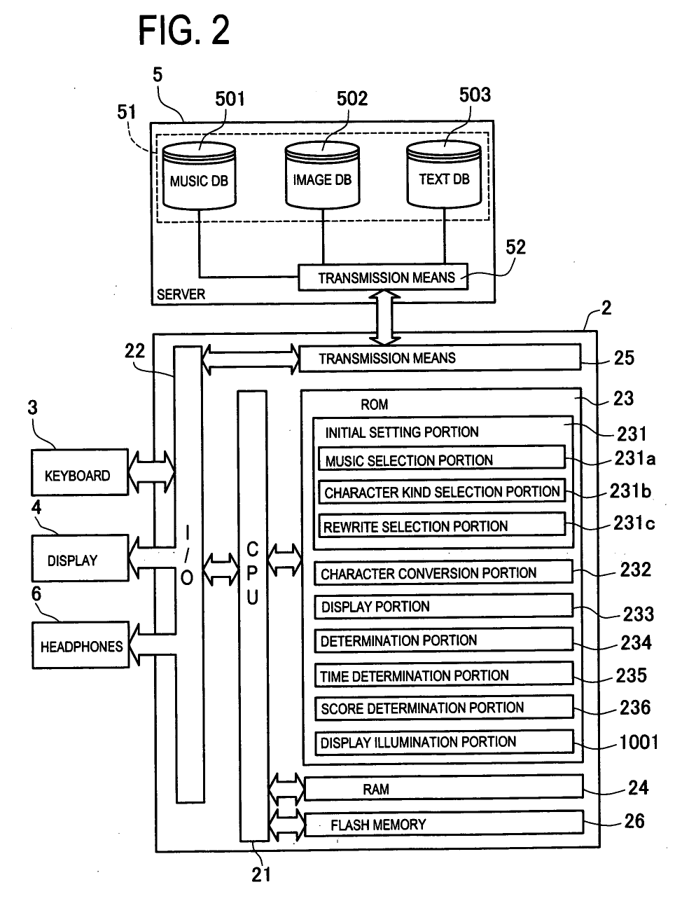

The body 2 is a control device in which an OS (Operating System) is installed, and the keyboard 3, the display 4 and the headphones 6 are connected to the body 2. The body 2 is, as shown in FIG. 2, is provided with a CPU (Central Processing Unit) 21, an I/O 22 of the body 2, a ROM (Read Only Memory) 23, a RAM (Random Access Memory) 24, a transmitting means 25 and a flash memory 26.

The CPU 21 is an central processing unit device which conducts various calculations according to various commands. The I/O 22 of the body 2 is a connection device through which the keyboard 3 separated as a module, the display 4 and the headphones 6 are directly or indirectly electrically connected to the CPU 21. The ROM 23 is a nonvolatile read only memory in which various programs to operate flowcharts mentioned later are stored. The RAM 24 is a volatile temporary memory capable of reading out and writing data used when the CPU 21 executes the programs. The RAM 24 temporarily stores music data (sound data, text data, image data) stored in the flash memory 26.

The transmission means 25 is a device which converts signals output from the computer through computer transmission into signals which can be transmitted through a telephone line or a LAN cable and restores transmitted signals to signals which can be read out by the computer. The transmission means 25 is connected to the server 5 through wireless or wire. The flash memory 26 is a memory in which data can be erased or written in many times and stores the music data received from the server 5. By storing the music data received from the server 5 in the flash memory 26, after power of the PC 10 is cut off, data are not erased in a case that the player wants to again conduct training for typing with the same music, therefore there is a case that it is not required to receive the same music data from the server 5.

Here, it will be described each of functions of the ROM 23 to operate flowcharts mentioned later. The ROM 23 has an initial setting portion 231, a character conversion portion 232, a display portion 233, a determination portion 234 for determining whether right or false, a time determination portion 235, a score determination portion 236 and a display illumination portion 1001.

The initial setting portion 231 has a music selection portion 231a, a character kind selection portion 231b and a rewrite selection portion 231c, and when the game is started, contents of the game (music, character kind) are set. The music selection portion 231a makes the player select the music title, receives data corresponding to the music title selected by the player from the server and stores the data in the RAM 24 or the flash memory 26. More concretely, the music input screen shown in FIG. 4 is displayed on the display 4. In the music input screen, there are provided an artist name input column in which the artist name is input and a music title input column in which a music title corresponding to the artist name is input. In both columns, the artist name and the music title are input from the keyboard 3. And when the player inputs the artist name and the music title in each of both columns in the music input screen, a music request signal is transmitted to the server 5 based on the input contents. Thereafter, image data, music data and text data corresponding thereto are received from the server 5 and stored in the RAM 24 or the flash memory 26. Here, in a case that the text data are stored in the RAM 24, such text data are divided into a plurality of phrases and stored every each phrase.

The character kind selection portion 231b makes the player select the character kind and the selected character kind is stored in the RAM 24. Here, the character kind means “cursive form of kana” and “alphabet”. As a general input method from the keyboard 3, there exist two input methods of “kana input method” in which characters are input through the keys 2001 of “ [symbol] ” and “Roman letters input method” in which characters are input through the keys 2001 of “A˜Z”. The player selects the character kind corresponding to the input method, thereby the player can train typing suitable therefor. For example, if the player inputs characters through the “Roman letters input method” and selects the “alphabet” as the character kind, the character line displayed is converted into the alphabet (Roman letters) through the character conversion portion 232 mentioned later and displayed, thereby it is enough for the player to type the characters displayed on the screen as they are. Thus, the player can smoothly conduct training for typing.

The rewrite selection portion 231c selects whether or not the music data are rewritten and stored in a case that the music data received from the server 5 are stored in the flash memory 26. Concretely, in a case that the music data received from the server 5 are stored in the flash memory 26, the rewrite selection portion 231c selects whether the music data stored in the flash memory 26 in the previous game are erased and stored in the flash memory 26 or the music data stored in the flash memory 26 are not erased and the music data newly received from the server 5 are stored in another area of the flash memory 26.

The character conversion portion 232 converts the character line (one phrase of text) stored in the RAM 24 into the character kind selected by the character line selection portion 231b and again stores them in the RAM 24. For example, if the character line such as “blue sky” is displayed and the “cursive form of kana” is selected as the character kind, such character line is converted into “ [symbol] ” and displayed. On the contrary, if the “alphabet” is selected as the character kind, the character line is converted into “AOISORA” and stored in the RAM 24.

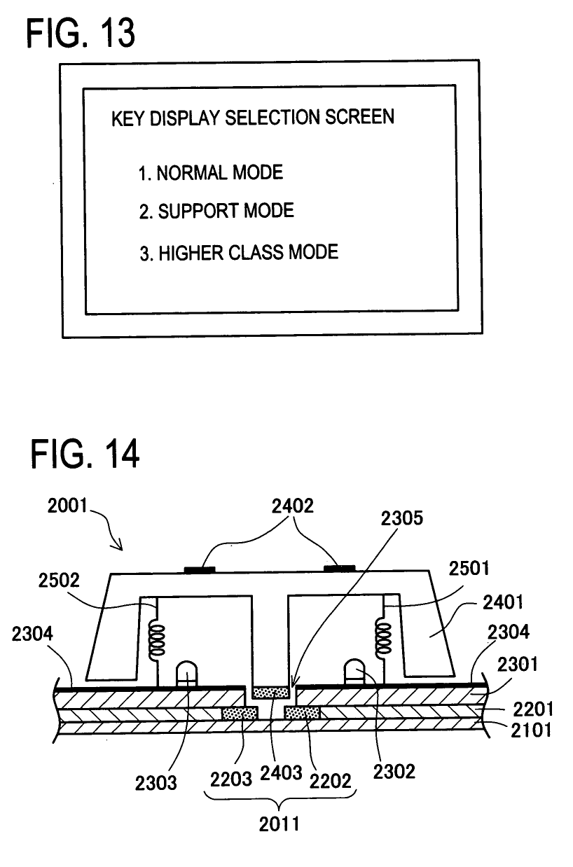

The display portion 233 displays the typing game screen of FIG. 3, the music input screen of FIG. 4 on which the player inputs the music at the start of the game and the key display selection screen of FIG. 13 on which the player selects the key display at the start of the game. And the display portion 233 displays the picture data stored in the RAM 24 on the picture screen 42 in the typing game screen of FIG. 3 and the character line which is converted by the character conversion portion 232 and stored in the RAM 24 on the character input screen 41. Here, the display portion 233 may display at the same time both the character line before converted and the character line after converted. In this case, according to difficulty for typing the character line displayed, there may be a case that the player can select whether or not the player types the character line before converted while seeing it or types the character line after converted while seeing it. Further, it is desirable that the character line is displayed in synchronism with the music heard through the headphones 6. Thereby, the player can train typing while riding on rhythm of the music.

In a case that the determination portion 234 (mentioned later) determines that the key 2001 input coincides with the key 2001 corresponding to the character displayed on the display 4, the display portion 233 changes a background color of the character coinciding with the key 2001 input (see FIG. 3). Thereby, the player can recognize to which character key input is successfully done in the character line displayed, thus key input can be easily conduced from the next character.

The determination portion 234 determines whether or not the input information 43 corresponding to each of the characters constructing the character line displayed on the display 4 coincides with the key 2001 input from the keyboard 3, and determined whether or not key input is successfully done against whole character line. And the determination portion 234 determines that key input is failingly done against the character line displayed on the display 4 if it is determined that a predetermined time elapses through the time determination portion 235.

The time determination portion 235 determines whether or not a predetermined time elapses since the character line is displayed on the display 4. That is to say, the time determination portion 235 determines whether or not the character line appearing on the upper portion of the character input screen 41 moves downward and exceeds the timing line 41a.

The score determination portion 236 determines the game score of the player based on a determination result by the determination portion 234. For example, at the start of the game, 10000 points are stored as a start score in the RAM 24 and 100 points are subtracted every it is determined by the determination portion 234 that key input against the character line is failingly done and such score is displayed on the display 4.

The display illumination portion 1001 sets whether or not the LEDs 2302, 2303 within the key 2001 are turned on. Further, if it is determined that the LEDs 2302, 2303 within the key 2001 are turned on, the display illumination portion 1001 instructs the timing and the color with which the LEDs 2302, 2303 within the key 2001 are turned on.

Concretely, in the key display selection screen of FIG. 13, if the player selects a higher class mode, it is set the higher class mode in which the LEDs 2302, 2303 within all of the keys 2001 are turned off during the game. In this case, as mentioned in the above, the transparent keytop 2401 is recognized in black color which is the surface color of the surface 2304 of the illumination circuit board 2401, thereby the key information 2402 printed in black color on the keytop 2401 recognized as black color is hard to recognize, or impossible or difficult to confirm through eyes. Thus, the player recognizes the keyboard 3 as shown in FIG. 18.

And in the key display selection screen of FIG. 13, if the player selects a normal mode, it is set the normal mode in which the LEDs 2302, 2303 within all of the keys 2001 are turned on in white color during the game. In this case, as mentioned in the above, the transparent keytop 2401 is recognized in white color on the basis of light emitted from the LEDs 2302, 2303, thereby the key information 2402 printed in black color on the keytop 2401 recognized as white color is easily recognized. Thus, the player recognizes the keyboard 3 as shown in FIG. 16.

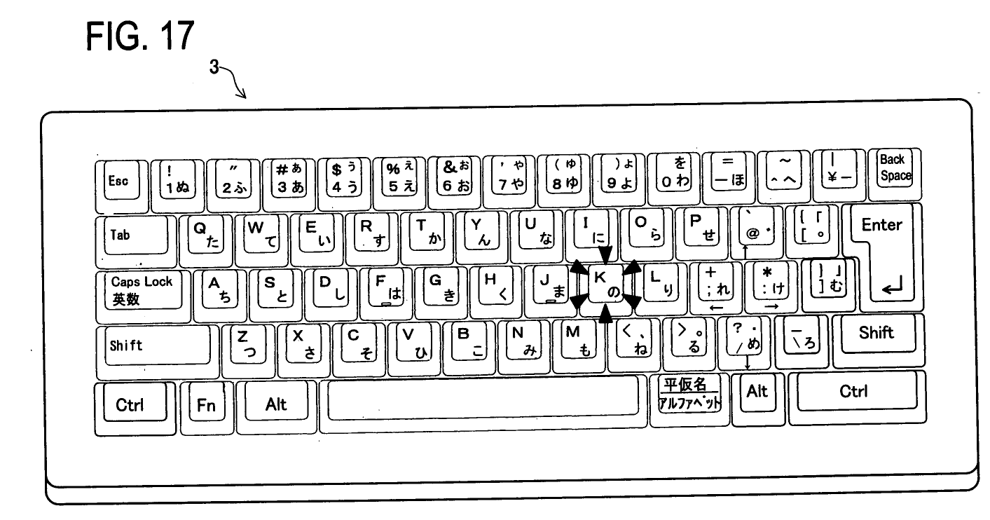

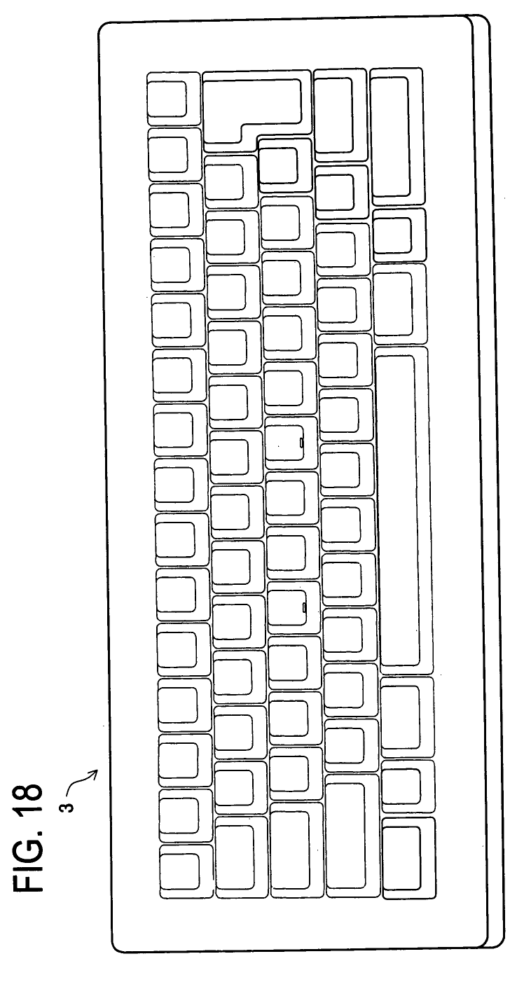

And in the key selection screen shown in FIG. 13, if the player selects a support mode, it is set the support mode in which the LEDs 2302, 2303 within all of the keys 2001 are turned on in white color, similar to the normal mode, and further, as for the key 2001 corresponding to the character representing one phrase displayed on the display 4, so long as such character is displayed at the upper side of the timing line 41a, the LEDs 2302, 2303 within the key 2001 are turned on so as to change color from white color to green color. Generally in this case, as mentioned in the above, the transparent keytop 2401 is recognized in white color on the basis of light emitted from the LEDs 2302, 2303, thereby the key information 2402 printed in black color on the keytop 2401 recognized as white color is easily recognized. Thus, the player recognizes the keyboard 3 as shown in FIG. 16. However, as for the key 2001 corresponding to the character representing one phrase displayed at the upper side of the timing line 41a, the transparent keytop 2401 is recognized in green color on the basis of light emitted from the LEDs 2302, 2303, thereby the keytop 2401 recognized in green color is easily recognized while the other keytops are recognized in white color. For example, for convenience's sake of explanation, in a case that the character representing one phrase displayed at the upper side of the timing line 41a is the character “ [symbol] ” and the input method is set to the input method of “cursive form of kana”, the keytop 2401 corresponding to the character “ [symbol] ” is recognized in green color and the keytops 2401 of the other keys 2001 recognized in white color, thereby the player recognizes the keyboard 3 as shown in FIG. 17 and can distinguish the position of the key 2001 corresponding to the character “ [symbol] ” on the basis of the color of the keytop 2401. Therefore, it can be navigated for the player which key 2001 is to be pressed and operated at present.

Further, in any of the normal mode, the higher class mode and the support mode, if it is determined by the determination portion 234 that the key 2001 input coincides with the key 2001 corresponding to the character displayed on the display 4, the LEDs 2032, 2303 within such key 2001 are temporarily turned on in blue color, thereby the keytop 2401 of such key 2001 is temporarily made in blue color. On the other hand, if it is determined by the determination portion 234 that the key 2001 input does not coincide with the key 2001 corresponding to the character displayed on the display 4, the LEDs 2032, 2303 within such key 2001 are temporarily turned on in red color, thereby the keytop 2401 of such key 2001 is temporarily made in red color.

Accordingly, it can be notified to the player through the color of the keytop 2401 of the key 2001 which is pressed and operated, whether press operation of the key 2001 is correct or false.

The server 5 connected to the PC 10 constructed according to the above so that data transmission can be conducted therebetween, is provided with a memory area 51 for storing the music data, transmission means 52 for connecting to the PC 10 so that data transmission can be conducted therebetween, a ROM for storing programs through which the music data stored in the memory area 51 are extracted based on the request signal output from the PC 10 and the music data are transmitted from the transmission means 52 to the PC 10, and a CPU (not shown). The memory area 51 has a music data base 501, an image data base 502 and a text data base 503. In the music data base 501, the sound data to sound the music from the headphones 6 are stored. In the image data base 502, there are stored image data, for example, such as promotion video data of the music, which are projected on the picture screen 42 of the game screen. And in the text data base 03, the text data corresponding to the text of the music are stored. The CPU of the server 5 extracts the sound data, the image data and the text data corresponding to the music request signal received from each of the data bases, and transmits them to the PC 10 requesting the above data.

Here, each data is classified every each of the artist names and stored, and based on the artist name input on the music input screen mentioned above, the music data can be faster transmitted to the PC 10. And by storing the music data in the server 5, it is not required to store the music data in the PC 10 beforehand, and the player can always train typing while using the newest music in the PC 10 by only renewing the data bases in the server 5. Further, in a case that a plurality of PCs 10 are connected to the server 5, each of the PCs 10 can commonly use the music data, thereby the player using each of the PCs 10 can faster obtain the newest music data if the music data in the server 5 is renewed.

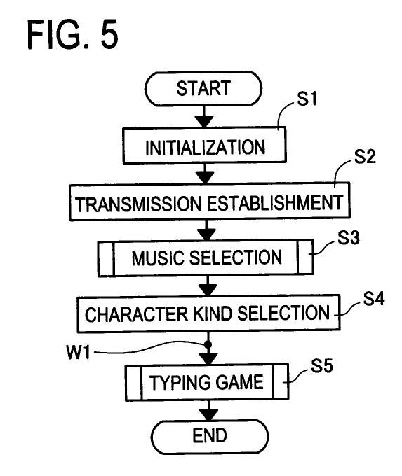

Next, operation of the terminal device in the typing training system 1 will be described with reference to FIGS. 5 to 8.

At first, in the PC 10, the CPU 21 conducts initialization at the start of the game (step (hereinafter, abbreviated as “S”) 1). Concretely, initialization of contents stored in the RAM 24 and transmission data is executed, and contents stored in the RAM 24 at the time that the game is terminated, are continuously erased. That is to say, erasing of data in a rewritable area of the RAM 24 used in the previous game, writing of parameters necessary for the next game in the rewritable area of the RAM 24, for example, writing of the game score 10000 points, direction of start address in a sequence program in the next game and display of the typing game screen on the display 4, are conducted.

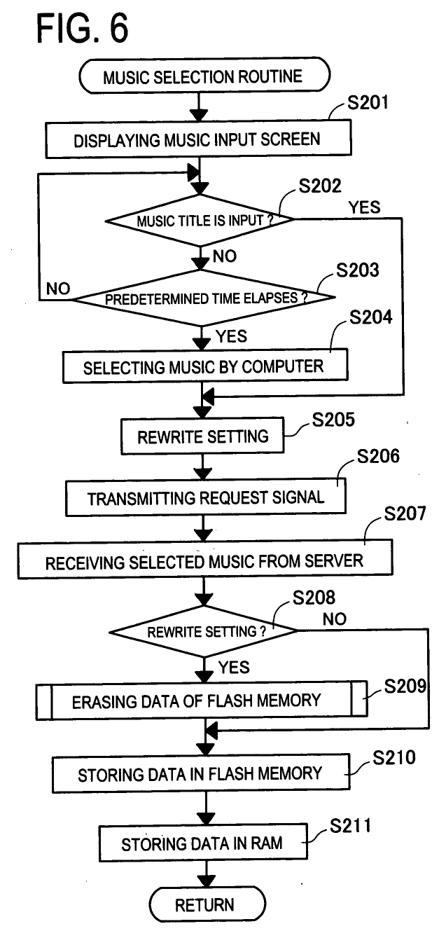

Next, transmission with the server 5 is established (S2). At that time, if transmission cannot be done with the server 5, it may be displayed on the display 4 contents representing that abnormality occurs. If transmission is established with the server 5, the music is selected (S3). That is, a music selection routine shown in FIG. 6 is executed and a music input screen shown in FIG. 4 is displayed on the display 4 (S201). Next, it is determined whether or not the artist name and the music title are input on the music input screen (S202). If it is determined that the artist name and the music title are not input (S202: NO), it is determined whether or not a predetermined time elapses under a state that the artist name and the music title are not input (S203).

If it is determined that the predetermined time does not elapse (S203: NO), procedure returns to S202. If it is determined that the predetermined time elapses (S203: YES), the PC 10 generates a random number and randomly selects the music title on the basis of the random number (S204). Concretely, a table in which predetermined music titles are stored beforehand is provided and the music title is randomly selected among the music titles in the table based on the random number generated. And the music data are received from the server 5 and it is set whether or not the music data are rewritten when stored in the flash memory 26 (S205).

And in S202, if it is determined that the artist name and the music title are input (S202: YES), the music data are received from the server 5 and it is set whether or not the music data are rewritten when stored in the flash memory 26 (S205). Thereafter, based on the music title input in S202 or the music title randomly selected in S204 by the computer, the music request signal is transmitted to the server 5 (S206). The server 5 extracts the sound data, the image data and the text data corresponding to the music request signal received from each of the data bases and transmits them to the PC 10 (S207). And the PC 10 receives the sound data, the image data and the text data transmitted from the server 5 (S207). Here, in this step, a warning screen may be displayed if the artist name and the music title input on the music input screen do not coincide with each other or the music data corresponding to the contents input on the music input screen do not exist in the server 5.

Next, if the set condition in S205 is the rewriting set (S208: YES), the music data in the flash memory 26 are erased (S209). That is to say, the music data, which are received from the server in the previous games and stored in the flash memory 26, are erased. Thereafter, the music data newly received are stored in the flash memory 26 (S210). Thereafter, the music data stored in the flash memory 26 are stored in the RAM 24 (S211). At that time, the text data are divided into plural phrases and stored every phrase. And if the set condition is not the rewriting set (S208: NO), the music data newly received are stored in another area of the flash memory 26 (S210) different from the area in which the music data received from the server 5 in the previous games are stored. And the music data stored in the flash memory 26 are stored in the RAM 24 (S211). Thereafter, this routine is terminated.

Next, the character kind is selected (S4). Concretely, the player selects the character kind that the player wants to train typing. For example, if the player wants to train “cursive form of kana”, the “cursive form of kana” is selected as the character kind by the player. Here, the character kind selected is stored in the RAM 24 as a set value.

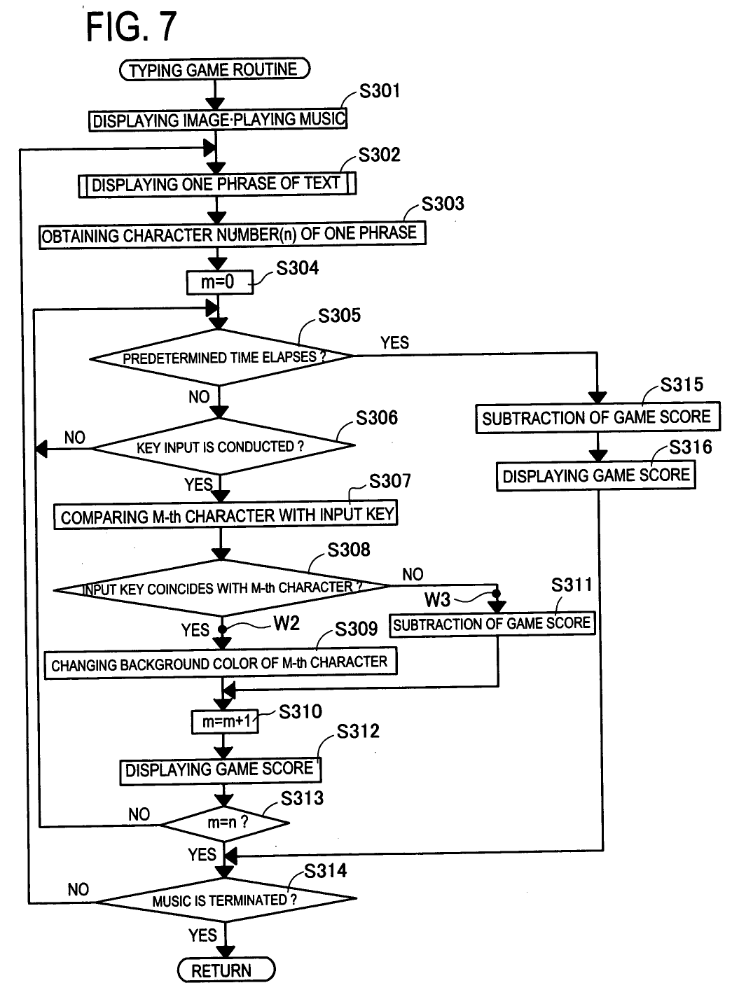

Next, based on the set values in the above, the player plays the game (S5). That is, a typing routine shown in FIG. 7 is executed and the image of the music is displayed on the display 4 (S301). Concretely, the typing game screen shown in FIG. 3 is displayed on the PC 10 used by the player, and in S210 of FIG. 6, the image data received from the server 5 and stored in the RAM 24 are displayed on the picture screen 42. And at the same time, the sound data received are sounded through the headphones 6. Next, the character line, namely, one phrase of the text, is displayed (S302).

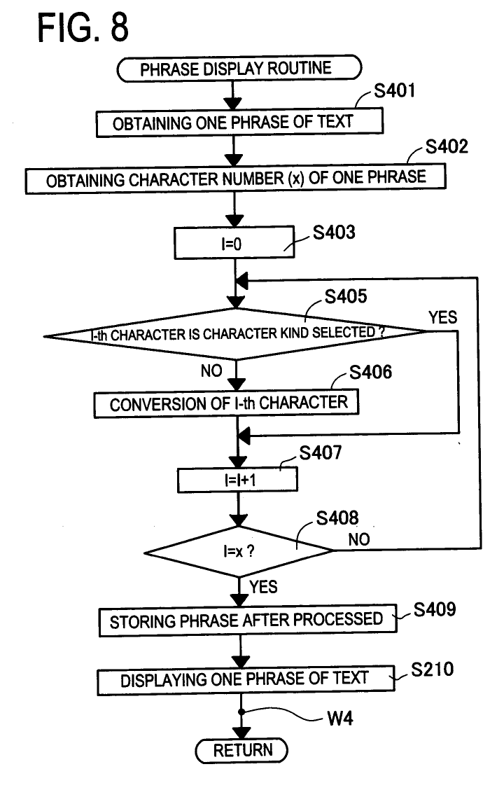

That is to say, a phrase display routine shown in FIG. 8 is executed and one phrase of the text stored in the RAM 24 (S401) is obtained. And a character number I of one phrase is obtained (S402), and “0” is substituted for the variable I (S403). Here, the voluntary variable I is a variable used in determination of the character kind corresponding to the first character of one phrase, and the first character of one phrase is set 0-th.

And it is determined whether or not the first character of one phrase is the character kind selected in S4 (S405). If it is determined that the first character is the character kind selected in S4 (S405: NO), the first character is changed to a character corresponding to the character kind selected (S406). Thereafter, a value obtained by adding 1 to the voluntary variable I is again substituted for the variable I (S407). And it is determined whether or not I=I, that is, the character kind is determined till the last character of one phrase (S408). And if it is determined that the first character is the character kind selected in S4 (S405: YES), procedure shifts to S407. And in S408, if it is determined that the relation I=I is not realized, that is, the character kind is not determined till the last character of one phrase (S408: NO), procedure returns to S405, and it is repeated against the remaining text data stored in the RAM 24 determination whether or not the first character of the phrase is the character kind selected in S4. On the other hand, in S408, if it is determined that the relation I=I is realized, that is, the character kind is determined till the last character of one phrase (S408: YES), the phrase after converted is stored in the RAM 24 (S409).

And as shown in FIG. 3, one phrase obtained in S401 and one phrase stored in S409 are arranged with up and down relation therebetween and are displayed at the upper side of the character input screen 41 in the game screen (S410). One phrase of the text displayed moves to the downward direction in the character input screen 41.

Procedure again returns to the typing game routine shown in FIG. 7 and the character number n of one phrase in the text displayed in S302 is obtained (S303). Here, if a translation sentence is displayed, process for the translation sentence is not done. And “0” is substituted for a voluntary variable m (S304). Here, the voluntary variable m is a variable used in determination whether key input for the m-th character of one phrase is correct or false and the first character of one phrase is set to 0-th.

In S302, after one phrase of the text is displayed, it is determined whether or not a predetermined time elapses (S305). That is to say, in FIG. 3, it is determined whether or not one phrase of the text appearing at the upper side of the character input screen moves in the downward direction and exceeds the timing line 41a. If it is determined that the predetermined time does not elapse (S305: NO), that is, if it is determined that one phrase does not exceed the timing line 41a, thereafter it is determined whether or not key input is conducted from the keyboard 3 (S306). If it is determined that key input is not conducted (S306: NO), procedure returns to S305 and it is again determined whether or not the predetermined time elapses.

If it is determined that key input is conducted (S306: YES), the key 2001 input is compared with the m-th character in the character line of the text (S307). More concretely, the key 2001 input and the key 2001 corresponding to the m-th character in one phrase of the text are compared with each other. And it is determined whether or not the m-th character coincides with key 2001 input (S308). If it is determined that the key 2001 input coincides with the m-th character (S308: YES), the background color of the m-th character is changed (S309). Thereby, the player can recognize that key input for the m-th character in one phrase of the text is successfully conducted. Thus, the player can continue key input of the next character, thereby the player can smoothly train typing. Further, the value obtained by adding 1 to the voluntary variable m is again substituted for the variable m (S310).

In S305, if it is determined that the predetermined time elapses (S305: YES), it is determined that key input against the phrase displayed is failed and the game score is subtracted (S315). That is to say, points due to fail of key input (for example, “100” points) are subtracted from the score data stored in the RAM 24 and the subtracted score is again stored in the RAM 24. And such game score is displayed (S316). Further, it is determined whether or not the music is terminated (S314). And in S308, if it is determined that the key 2001 does not coincide (S308: NO), the game score is subtracted (S311). Thereafter, procedure shifts to S310. And the game score is displayed (S312).

In S310, after the value obtained by adding 1 to the voluntary variable m is again substituted for the variable m, it is determined whether or not a relation m=n is realized, that is, the value of the variable m becomes the same value of the character number n of one phrase in the text (S313). If the relation m=n is not realized (S313: NO), it is determined that key input for all of the characters in one phrase of the text is not finished and procedure returns to S305 and the above processes are repeated. If the relation m=n is realized (S313: YES), it is determined that key input for all of the characters in one phrase of the text is finished and it is determined whether or not the music is terminated (S314). If it is determined that the music is terminated (S314: YES), this routine is terminated. And if it is determined that the music is not terminated (S314: NO), procedure returns to S302 and above processes are repeated for the text data remained in the RAM 24. Thereafter, procedure returns to FIG. 5 and the typing game is terminated.

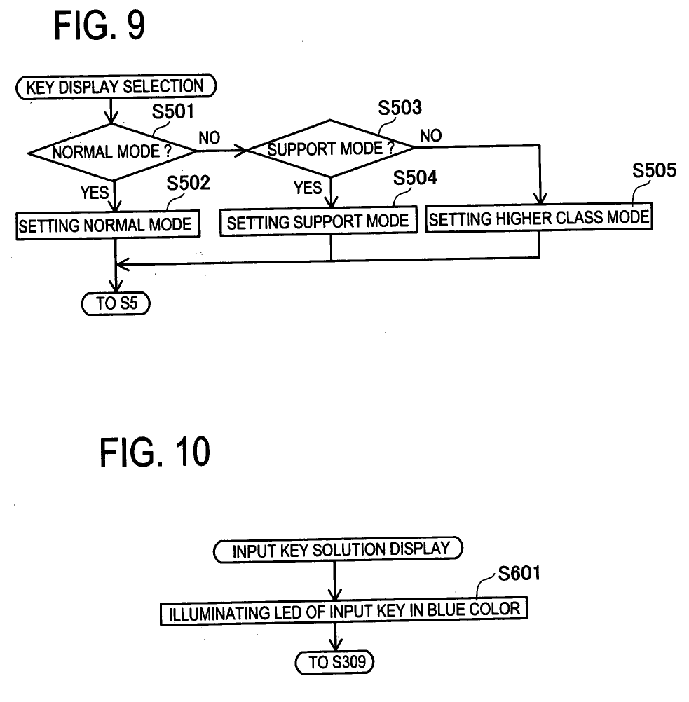

Further, in the embodiment, at a timing W1 between S4 and S5 in the main routine shown in FIG. 5, a key display selection routine is conducted. FIG. 9 is a flowchart of the key display selection routine. That is to say, after procedure shifts to the key display selection routine from S4 in the main routine in FIG. 5, as shown in FIG. 9, at first in S501 it is determined whether or not the player selects the normal mode. At that time, if it is determined that the player selects the normal mode (S501: YES), procedure shifts to S502 and the normal mode is set. Thereafter, the key display selection routine is terminated and procedure shifts to S5 of the main routine in FIG. 5.

Here, if the normal mode is set, the LEDs 2302, 2303 within all of the keys 2001 are continued to turn on in white color.

On the other hand, if it is determined that the player does not select the normal mode (S501: NO), procedure shifts to S503 and it is determined whether or not the player selects the support mode. At that time, if it is determined that the player selects the support mode (S503: YES), procedure shifts to S504 and the support mode is set. Thereafter, the key display selection routine is terminated and procedure shifts to S5 of the main routine in FIG. 5. On the contrary, if it is determined that the player does not select the support mode (S503: NO), procedure shifts to S505 and the higher class mode is set. Thereafter, the key display selection mode is terminated and procedure shifts to S5 of the main routine in FIG. 5.

Here, if the support mode is set, thereafter the LEDs 2302, 2303 within all of the keys 2-001 are continued to turn on in white color. At that time, as for the key 2001 corresponding to the character representing one phrase displayed at the upper side of the timing line 41a on the display 4, so long as such character is displayed at the upper side of the timing line 41a on the display 4, the LEDs 2302, 2303 within such key 2001 continued to turn on while changing color thereof from white color to green color.

And if the higher class mode is set, thereafter the LEDs 2302, 2303 within all of the keys 2001 are continued to turn off.

Further, in the embodiment, at a timing W2 between S308 and S309 shown in the typing game routine in FIG. 7, an input key solution display routine is executed. FIG. 10 is a flowchart of the input key solution display routine. That is to say, after procedure shifts to the input key solution display routine from S308 of the typing game routine in FIG. 7, as shown in FIG. 10, in S601, the LEDs 2302, 2303 within the key 2001 input are temporarily turned on in blue color. Thereafter the input key solution display routine is terminated, and procedure shifts to S309 of the typing game routine in FIG. 7.

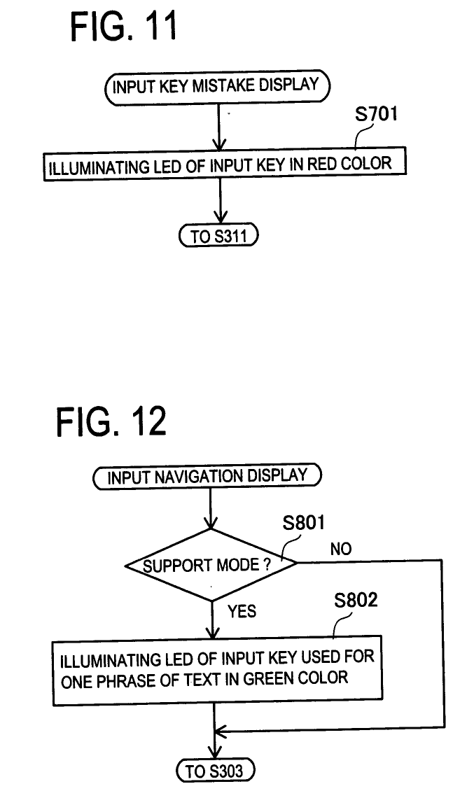

And in the embodiment, at a timing W3 between S308 and S311 shown in the typing game routine in FIG. 7, an input key mistake display routine is executed. FIG. 11 is a flowchart of the key input mistake display routine. That is to say, after procedure shifts to the key input mistake display routine from S308 of the typing game routine in FIG. 7, as shown in FIG. 11, in S701, the LEDs 2302, 2303 within the key 2001 input are temporarily turned on in red color. Thereafter, the key input mistake display routine is terminated and procedure shifts to S311 of the typing game routine in FIG. 7.

And in the embodiment, at a timing W4 right after S410 shown in a phrase display routine in FIG. 8, an input key navigation display routine is executed. FIG. 12 is a flowchart of the input key navigation display routine. That is to say, after procedure shifts to the input key navigation display routine from S410 shown in the phrase display routine in FIG. 8, as shown in FIG. 12, at first, in S801, it is determined whether or not the support mode is set.

At that time, if it is determined that the support mode is set (S801: YES), procedure shifts to S802, and as for the key 2001 corresponding to the character representing one phrase displayed at the upper side of the timing line 41a on the display 4, so long as such character is displayed at the upper side of the timing line 41a on the display 4, the LEDs 2302, 2303 within such key 2001 are turned on while changing color thereof from white color to green color. Thereafter, the input key navigation display routine is terminated and procedure returns to the phrase display routine in FIG. 8. Further, procedure shifts to S303 of the typing game routine in FIG. 7.

On the other hand, if it is determined that the support mode is not set (S801: NO), the input key navigation routine is terminated and procedure returns to phrase display routine in FIG. 8. Further, procedure shifts to S303 of the typing game routine in FIG. 7.

As mentioned in the above in detail, the PC 10 of the embodiment compares the key 2001 input with the m-th character in the character line in S307 of the typing game routine in FIG. 7, and determines in S308 of the typing game routine in FIG. 7 whether or not the key 2001 input coincides with the m-th character in the character line, therefore the PC 10 conducts the typing game. And before the typing game is started, if the higher class mode is selected and set through S501, S503, S505 of the key display selection routine in FIG. 9, the LEDs 2302, 2303 within all of the keys 2001 in the keyboard 3 are turned off and all of the transparent keytops 2004 are recognized in black color which is the color of the surfaces 2304 of the illumination circuit board 2301. Thereby, the key information 2402 printed in black color on all of the keytops 2401 recognized in black color, is hard to recognize, or impossible or difficult to confirm through eyes, thus the player recognizes the keyboard 3 as shown in FIG. 18. Therefore, based on that the player plays the typing game by using the keyboard in this state, the typing game with interest different from that in the conventional typing game can be conducted.

Further, in the PC 10 of the embodiment, while the typing game is conducted, in S308 of the typing game routine in FIG. 7, it is determined that the key 2001 input coincides with the m-th character in the character line, procedure shifts to the input key solution display routine in FIG. 10, and in S601, the LEDs 2302, 2303 within the key 2001 input are temporarily turned on in blue color, thereby the keytop 2401 of the key 2001 input is temporarily made blue color. On the other hand, in S308 of the typing game routine in FIG. 7, if it is determined that the key 2001 input does not coincide with the m-th character in the character line, procedure shifts to the input key mistake display routine in FIG. 11, and in S701, the LEDs 2302, 2303 within the key 2001 input are temporarily turned on in red color. Thereby, the keytop 2401 of the key 2001 input is temporarily made red color. Therefore, the player can recognize on the keyboard 3 whether press operation of the key 2001 is correct or false, through the color of the keytop 2401 right after input operation thereof. As a result, the typing game with interest different from that in the conventional typing game can be conducted.

Although the player unconsciously sees the keyboard 3 if the arrangement position of the key 2001 cannot be understood, in this case, it is difficult to determine by himself/herself whether press operation of the key 2001 is correct or false. At that time, in the PC 10 of the embodiment, since the player can recognize on the keyboard 3 whether press operation of the key 2001 is correct or false, through color of the keytop 2401 of the key 2001 right after press operation thereof, the player can immediately confirm whether press operation of the key 201 is correct or false. Further, in the PC 10 of the embodiment, in a case that the key to be pressed and operated is navigated, the keytop 2401 of the key 2001 to be pressed and operated is recognized in green color (S802), thereby the arrangement position of the key 2001 can be immediately recognized and remembered, thus the PC 10 can contribute to learning of blind touch.

And in the PC 10 of the embodiment, through S501 to S505 of the key display selection routine in FIG. 9, it can be done to select and set the higher class mode and to select and set the normal mode or the support mode different from the higher class mode. Here, in the keyboard 3, after the normal mode or the support mode is selected and set, the LEDs 2302, 2303 within all of the keys 2001 are turned on in white color and all of the transparent keytops 22401 are recognized in white color on the basis of light emitted from the LEDs 2302, 2303. Thereby, the key information 2402 printed in black color on the keytop 2401 recognized in white color is easily recognized, thus the player recognizes the keyboard 3 as shown in FIG. 16.

Therefore, if contents of the typing game are easier for the player on the basis of typing level, the higher class mode is selected and set, thereby the LEDs 2302, 2303 are turned off and all of the keytops 2401 are recognized in black color. Accordingly, the key information 2402 printed in black color on the keytop 2401 recognized in black color is hard to recognize, or impossible or difficult to confirm, as a result, contents of typing game can be made difficult for the player. On the other hand, if contents of typing game are difficult for the player on the basis of typing level, the normal mode or the support mode is selected and set, thereby the LEDs 2302, 2303 are turned on in white color and all of the keytops 2401 are recognized in white color. Accordingly, the key information 2402 printed in black color on the keytop 2401 recognized in white color is easy to recognize, as a result, contents of typing game can be corresponded to typing level of the player.

And in the typing game, there will be a case that the player unconsciously see the key information 2402 printed on the keytop 2401 and such seeing becomes obstruction to learn blind touch. In this point of view, in the PC 10 of the embodiment, if the higher class mode is selected and set, as mentioned in the above, the key information 2402 printed on the keytop 2401 becomes hard to recognize. Therefore, even if the player unconsciously sees the key information 2402, the key information 2402 printed on the keytop 2401 is hard to recognize, or the key information 2402 printed on the keytop 2401 is impossible or difficult to confirm, thus, according to the above situation, learning of blind touch can be improved.

Here, the present invention is not limited to the embodiment, and various modifications and changes may be done within the scope of the present invention. That is, in the embodiment, although the score determination portion 236 determines the score by subtracting some points from the score stored at the start of the game every mistake of key input occurs, the score determination method is not limited to the above. For example, it may be used a method that the score “0” is set at the start of the game and some points are added every key input is successfully done. And in the embodiment, although the PC is used as the terminal device of the typing training system, it is not limited to this. It may be used a terminal device to which the keyboard capable of inputting keys can be connected.

And in the embodiment, although the music input screen is displayed to select the music title and the like, it is not limited to this. For example, it may be conceivable a case that, based on that the artist name is input, the music titles concerning with the artist name are displayed in a table and the player selects the music title from the table. In this case, even if the player knows the artist name but does not know the music title, there may be a case that the player can select the music. Further, in the embodiment, although the flash memory 26 is used as the memory capable of rewriting, for example, a HD (hard disc) may be used. And although the music data received from the server 5 are stored in the flash memory 26 and thereafter stored in the RAM 24, such music data may be stored in both the flash memory 26 and the RAM 24 at the same time when the music data are received. Thereby, a time to read in the music data can be shortened.

And in the PC 10 of the embodiment, as shown in FIGS. 2 and 15, the CPU 21 in the body 2 instructs to the illumination circuit 3002 within the keyboard 3, thereby the LEDs 2302, 2303 within all of the keys 2001 are controlled to turn on or off. Here, it may be constructed that a sub-CPU is provided within the keyboard 3 and the LEDs 2302, 2303 within all of the keys 2001 are controlled to turn on of off through the sub-CPU.

Further, in the PC 10 of the embodiment, if the LEDs 2302, 2303 within all of the keys 2001 are turned off, all of the keytops 2401 are recognized in black color which is the color of the surface 2304 of the illumination circuit board 2302. Accordingly, the key information 2402 printed in black color on the keytop 2401 recognized in black color is hard to recognize, or impossible or difficult to confirm, as a result, the player recognizes the keyboard as shown in FIG. 18. At this point of view, by turning on the LEDs 2302, 2303 within all of the keys 2001, it may be conceivable that the key information 2402 printed on all of the keytops 2401 are made hard to recognize, or impossible or difficult to confirm through eyes.

In order to realize the above, for example, the key information 2402 for all of the keytops 2401 is printed in white color. In this case, if the LEDs 2302, 2303 within all of the keys 2001 are turned off, all of the transparent keytops 2401 are recognized in black color which is the color of the surface 2304 of the illumination circuit board 2301, thereby the key information 2402 printed in white color on the keytop 2401 recognized in black color is easy to recognize. At that time, the player recognizes the keyboard 3 as shown in FIG. 16. On the other hand, if the LEDs 2302, 2303 within all of the keys 2001 are turned on in white color, all of the transparent keytops 2401 are recognized in white color. Thereby, the key information 2402 printed in white color on all of the keytops 2401 is hard to recognize, or impossible or difficult to confirm through eyes, as a result, the player recognizes the keyboard 3 as shown in FIG. 18.

And in the PC 10 of the embodiment, if the higher class mode is set, the player recognizes the keyboard 3 as shown in FIG. 18, thereby the key information 2402 printed in all of the keytops 2401 can be made hard to recognize, or impossible or difficult to confirm through eyes. However, it may be conceivable that the key information 2402, which is made hard to recognize, can be selected when the higher class mode is set, and the LEDs 2302, 2303 within the keytop 2401 on which the selected key information 2402 is printed, are controlled to turn of or turn off, thereby only the key information 2402 printed on a specific keytop 2401 may be made hard to recognize, or impossible or difficult to confirm through eyes.

Further, in the keyboard 3 of the PC 10 according to the embodiment, based on that the LEDs 2302, 2303 within the key 2001 which is correctly pressed and operated are temporarily turned on in blue color, the keytop 2401 of the above key 201 is recognized in blue color. At that time, the LEDs 2302, 2303 may be blinked. Further, based on that the LEDs 2302, 2303 within all of the keys 2001 are temporarily turned on or blinked in blue color, the keyboard 3 may be entirely temporarily turned on or blinked in blue color. This manner can be similarly done for red color according to which the LEDs 2302, 2303 are turned on if the key 2001 is falsely pressed and operated.

And in the PC 10 of the embodiment, if the support mode is set, thereafter the LEDs 2302, 2303 within all of the keys 2001 are continued to turn on in white color, and as for the keys 2001 corresponding to the character representing one phrase displayed at the upper side of the timing line 41a on the display 4, so long as such character is displayed at the upper side of the timing line 41a on the display 4, the LEDs 2302, 2303 within such keys 2001 are continued to turn on while changing color from white color to green color. At that time, while the character representing one phrase is displayed at the upper side of the timing line 41a on the display 4, if all of the keys corresponding to the characters cannot be pressed and operated according to the correct order, the LEDs 2302, 2303 within all of the keys 2001 may be temporarily blinked when the character representing one phrase is displayed from the upper side to the under side of the timing line 41a on the display 4.

That is to say, it may be notified to the player by turning on or blinking the LEDs 2302, 2303 within the key 2001 whether the timing of press and operation of the key 2001 is correct or false.

And in the keyboard 3 of the PC according to the embodiment, as for the color according to which the LEDs 2302, 2303 within the key 2001 are turned on, if the key information 2402 is made easy to recognize the LEDs 2302, 2303 are turned in white color (S502, S504), if the key 2001 is correctly pressed and operated the LEDs 2302, 2303 are tuned in blue color (S601), if the key 2001 is falsely pressed and operated the LEDs 2302, 2303 are turned on in red color (S701) and if the key 2001 to be pressed and operated is navigated the LEDs 2302, 2303 are turned on in green color (S802). Here, if the purposes mentioned in the above can be realized, each of the above colors in each case may be another color. And the key information 2402 may be three-dimensionally displayed when the LEDs 2302, 2303 within the key 2001 are turned on, based on that the key information 2402 is three-dimensionally attached to the keytop 2401.

Further, in the keyboard 3 of the PC 10 according to the embodiment, as for the color according to which the LEDs 2302, 2303 within the key 2001 are turned on, if the key 2001 is correctly pressed and operated the LEDs 2302, 2303 are tuned in blue color (S601) and if the key 2001 is falsely pressed and operated the LEDs 2302, 2303 are turned on in red color (S701). Here, for example, when it is conducted the typing game in which only one press and operation for each of the keys 2001 is required during one game, after the LEDs 2302, 2303 within all of the keys 2001 may be turned on before the game is started, the LEDs 2302, 2303 within the key 2001 may be turned off if the key 2001 pressed and operated is correct.

What is claimed is:

1. A gaming machine comprising:
a display device for displaying input information thereon;
a keyboard for conducting key input corresponding to the input information displayed on the display device, the keyboard being provided with a plurality of keys each of which includes a transparent keytop on which key information is attached and an illumination element capable of emitting full color light, the illumination element being covered by the keytop;
an input determination device for determining whether or not the key information input through the key coincides with the input information displayed on the display device; and
an illumination control device for controlling the illumination element so as to turn on while changing a light color depending upon a determination result by the input determination device.

2. The gaming machine according to claim 1, further comprising:
an input mode selection device for selecting one input mode among plural input modes.

3. The gaming machine according to claim 2, wherein at least a first, a second and a third input modes are provided.

4. The gaming machine according to claim 3, wherein the key information is colored in a first color, and
wherein the illumination control device controls the illumination element so as to turn on in a second color when the first mode or the second mode is selected by the input mode selection device.

5. The gaming machine according to claim 4, wherein the illumination control device controls the illumination element so as to turn on in a third color when the input determination device determines that the key information input through the key coincides with the input information displayed on the display device.

6. The gaming machine according to claim 4, wherein the illumination control device controls the illumination element so as to turn on in a fourth color when the input determination device determines that the key information input through the key does not coincide with the input information displayed on the display device.

7. The gaming machine according to claim 3, wherein the key information is colored in black color, and
wherein the illumination control device controls the illumination element so as to turn off when the third input mode is selected by the input mode selection device.

8. The gaming machine according to claim 7, further comprising:
an illumination circuit board on a surface of which the illumination element is mounted;
wherein the surface of the illumination circuit board is colored in black color so as to become difficult or impossible to recognize the key information.

9. The gaming machine according to claim 3, wherein the key information is colored in a first color,
wherein the second input mode is a support mode to navigate the key to be pressed and operated, and
wherein the illumination control device controls the illumination element so as to turn on in a fifth color when the second mode is selected by the input mode selection device.

10. The gaming machine according to claim 1, further comprising:
a sound output device for outputting sounds corresponding to the input information displayed on the display device

11. A gaming machine comprising:
a display device for displaying input information thereon;
a keyboard for conducting key input corresponding to the input information displayed on the display device, the keyboard being provided with a plurality of keys each of which includes a transparent keytop on which key information is attached and an illumination element capable of emitting full color light, the illumination element being covered by the keytop;
an input determination device for determining whether or not the key information input through the key coincides with the input information displayed on the display device; and
an illumination control device for conducting illumination control of the illumination element so as to assimilate the key information with the transparent keytop.
